(19) United States
(12) Patent Application Publication
(10) Pub. No.: US 2019/0047092 A1
(43) Pub. Date: Feb. 14, 2019

(54) Aluminium Composite Material Having a Corrosion Protection Layer

(71) Applicants: Gerhard Bermig, Horneburg (DE); Nico Eigen, Hamburg (DE); Hartmut Janssen, Hilden (DE); Manfred Mrotzek, Buxtehude (DE); Volker Sass, Niederkassel-Mondorf (DE); Stefan Schlüter, Dusseldorf (DE)

(72) Inventors: Gerhard Bermig, Horneburg (DE); Nico Eigen, Hamburg (DE); Hartmut Janssen, Hilden (DE); Manfred Mrotzek, Buxtehude (DE); Volker Sass, Niederkassel-Mondorf (DE); Stefan Schlüter, Dusseldorf (DE)

(73) Assignee: Hydro Aluminium Rolled Products GmbH, Grevenbroich (DE)

(21) Appl. No.: 16/165,098

(22) Filed: Oct. 19, 2018

Related U.S. Application Data
(63) Continuation of application No. PCT/EP2017/050145, filed on Jan. 4, 2017.

(30) Foreign Application Priority Data
Apr. 19, 2016 (EP) 16166064.2

(51) Int. Cl. B23K 35/02; B32B 15/01; B23K 35/28; C22C 21/00; C22C 21/02

(52) U.S. Cl. CPC B23K 35/0238; B32B 15/016; C22C 21/02; C22C 21/00; B23K 35/288

(57) ABSTRACT

The invention relates to an aluminium composite material having at least one core layer of an aluminium core alloy and at least one corrosion protection layer arranged on the core layer. The aluminium composite material has improved corrosion resistance, in particular avoids coarse detachments under corrosive conditions, through use of a corrosion protection layer with the following composition in wt %: Si≤0.10%, Fe≤0.6%, Cu≤0.2%, 0.9%≤Mn≤1.2%, Mg≤0.10%, Cr≤0.3%, Zn≤0.1%, Ti≤0.1%, the rest Al and unavoidable impurities, individually at most 0.05%, in total at most 0.15%. The invention furthermore relates to a method for producing an aluminium composite material, a use as well as a heat exchanger or a component of a heat exchanger.

### CROSS-REFERENCE TO RELATED PATENT APPLICATIONS

This patent application is a continuation of PCT/EP2017/050145, filed Jan. 4, 2017, which claims priority to European Application No. 16166064.2, filed Apr. 19, 2016, the entire teachings and disclosure of which are incorporated herein by reference thereto.

### FIELD

The invention relates to an aluminium composite material, comprising at least one core layer having an aluminium core alloy and at least one corrosion protection layer provided on the core layer. The invention furthermore relates to a process for manufacturing an aluminium composite material, especially one according to the invention, with which a core layer comprising an aluminium core alloy is provided and at least one corrosion protection layer is applied onto the core layer. The invention further relates to a use of an aluminium composite material for manufacturing a heat exchanger as well as a component.

### BACKGROUND

In the automotive sector, heat exchangers made of aluminium or aluminium alloys are used. Such heat exchangers usually are components of the heating and cooling systems in motor vehicles. Heat exchangers for motor vehicles typically are manufactured from strips or sheets by thermal joining of the individual prefabricated components of the heat exchanger, such as fins, tubes and manifolds. The thermal joining is in most cases carried out as brazing under a protective gas atmosphere using non-corrosive flux, known as the “Controlled Atmosphere Brazing” (CAB) process.

The various tasks of such thermally joined heat exchangers made of aluminium materials, especially in vehicles with internal combustion engines, include the cooling of cooling water or of oil, the use as charge air coolers and the use in air conditioning systems. A requirement for the operation of the heat exchangers is an adequate protection against corrosion to ensure a long life of the systems.

Comprehensive corrosion protection is particularly important for charge air coolers. Charge air coolers cool the intake air compressed by a turbocharger and thus increase the oxygen content of the charge air, which leads to a considerable increase in the performance of internal combustion engines. In modern diesel engines, it is nowadays common to mix the intake air in certain load ranges with specific amounts of combustion gases via a so-called exhaust gas recirculation. This lowers the combustion temperature and thus reduces the undesirable formation of nitrogen oxides in the combustion process. With regard to the exhaust gas recirculation, a distinction is made between high-pressure exhaust gas recirculation and low-pressure exhaust gas recirculation. In low-pressure exhaust gas recirculation the exhaust gases are branched off at a relatively low temperature behind a diesel particulate filter and mixed with the sucked-in fresh air ahead of the turbocharger. The fresh air-exhaust gas mixture accordingly also passes through the charge air cooler and is in contact with its inner surface.

In the charge air cooler this can lead to the condensation of steam from the exhaust gases, and the condensate collecting inside the heat exchanger. In addition to water, the condensate may contain different proportions of organic and/or inorganic acids, which have a highly corrosive effect on the aluminium material of the charge air cooler. This effect occurs more intensively in modern charge air coolers with so-called indirect cooling, where the charge air is cooled by a liquid cooling medium, since particularly low surface temperatures are reached here and accordingly the formation of the condensate is promoted.

Furthermore, comprehensive corrosion protection, especially on water coolers and air-cooled condensers, is of great importance. Radiators cool the cooling water for the engine and for water-cooled heat exchangers in the motor vehicle, for example in the form of charge air coolers or condensers. Air-cooled condensers cool and condense a refrigerant in a refrigeration circuit, which usually serves to ensure the air conditioning of the passenger compartment in the motor vehicle. Water coolers and air-cooled condensers use the airstream that occurs during the driving and are therefore arranged in the motor vehicle in such a way that they can constantly come into contact with the ambient air. As a result, water coolers and air-cooled condensers are alternately exposed to dry as well as humid air, rain, salty media, etc. This places great demands on the corrosion protection and accordingly on the corrosion resistance of the tube material of the water cooler and air-cooled condensers. These requirements are further intensified, in particular due to the trend towards smaller wall thicknesses of the tube material, with which the absolutely permissible corrosion depth in the material is becoming ever smaller.

From the above problem arises the need for particularly corrosion resistant aluminium materials for use in heat exchangers. Aluminium composite materials having a core layer and optionally an outer brazing layer provided thereon can be improved in terms of the corrosion resistance by providing on the core layer or between the core layer and the brazing layer a corrosion protection layer or intermediate layer, which is characterised by a particularly high corrosion resistance and acts as a sacrificial anode in respect of the material of the core layer.

EP 0 823 305 A2 describes a four-layer aluminium composite material with an intermediate layer arranged between an outer brazing layer and a core layer. The intermediate layer is intended to serve as corrosion protection and consists of an alloy which is less noble than the material of the core layer. In particular, the aluminium alloy of the intermediate layer has an Mn content of 0.3 to 1.5 wt %, an Mg content of 0.05 to 1.2 wt %, and a Zn content of 1 to 5 wt %.

It has been found that with conventional aluminium composite materials, the specifications for a maximum mass loss can be met under corrosive conditions. However, in the conventional aluminium composite materials the mass loss that inevitably takes place in the case of corrosion can lead to detachments the size of which exceeds the maximum specifications. The size of the occurring detachments may during operation prove to be problematical for the life and reliability of the engines.

The present invention accordingly has the objective of indicating an aluminium composite material with further improved corrosion resistance, in particular to avoid coarse detachments under corrosive conditions. In addition, a method for producing an aluminium composite material, a use of the aluminium composite material as well as a component are to be indicated.

### BRIEF SUMMARY

According to a first teaching, the abovementioned invention relating to an aluminium composite material is achieved in that the at least one corrosion protection layer has an aluminium alloy with the following composition in wt.-%:

| | | | | |
|---|---|---|---|---|
| 0.9% | ≤ | Si | ≤ | 0.10%, |
| | | Fe | ≤ | 0.6%, |
| | | Cu | ≤ | 0.2%, |
| | | Mn | ≤ | 1.2%, |
| | | Mg | ≤ | 0.10%, |
| | | Cr | ≤ | 0.3%, |
| | | Zn | ≤ | 0.1%, |
| | | Ti | ≤ | 0.1%, |

the rest Al and unavoidable impurities, individually at most 0.05%, in total at most 0.15%.

The aluminium composite material with the specifically selected composition of the aluminium alloy of the corrosion protection layer exhibits, in addition to an extremely low material loss under corrosive conditions, a clearly improved bonding property with the core layer. As a result, coarse detachments of the aluminium composite material do not occur even under extremely corrosive conditions when exposed to acidic or alkaline media, as occur especially with charge air coolers, water coolers or condensers.

The improved corrosion protection properties of the at least one corrosion protection layer can be attributed in particular to an optimised microstructure of the corrosion protection layer. Relevant here is, in particular, the formation of the recrystallised grain structure in the component after the thermal joining, for example by a brazing process at typical brazing temperatures in the range of 590° C. to 610° C. Advantageous are a smallest possible size and an as equiaxed as possible grain shape. Our own investigations have shown that a strongly stretched grain shape, typical for so-called “long-life” heat exchanger materials, promotes pronounced lateral propagation of the corrosion attack under the particularly corrosive conditions that prevail inside charge air coolers through the action of corrosive condensates. This results in the danger that during use larger detachments of the corrosion protection layer, of an optionally provided brazing layer or its corrosion products, will form. By the inventive configuration of the corrosion protection layer in terms of its composition, a favourable fine-grained grain structure can be achieved, which limits the lateral spread of the corrosion and accordingly avoids the formation of larger detachments during operation.

The aluminium composite material can be present as a strip. Composite materials in the form of strips are manufactured by plating, in particular by roll-cladding. With the composition of the aluminium alloy of the corrosion protection layer, during the roll-cladding it is possible to achieve already at low rolling forces high strip qualities with good bonding properties between the layers. Of great importance during the roll-cladding is the adjustment of the forming resistance of the corrosion protection layer under the rolling conditions, especially during hot rolling. In this connection it has proved favourable when the rolling resistance of the corrosion protection layer lies between the values of the core material with greater strength and the values of an outer brazing layer with composition-related lower heat resistance. This applies especially in the case of a one-sided use of the corrosion protection layer. If the strength of the intermediate layer is too low, there is the risk that during the start of the rolling the intermediate layer will elongate too much, which leads to problems due to a bending of the plating pack as well as to process insecurity caused by strong fluctuations of the plating layer thicknesses. In the opposite case of too great a strength of the corrosion protection layer, the rolling forces required to produce a deformation in the corrosion protection layer will increase greatly and the formation of a strong bond between the layers of the composite material is inhibited.

It is also conceivable that the aluminium composite material is in the form of sheets, which are separated, for example, from a strip.

In particular, the at least one corrosion protection layer is applied to one or both sides of the core layer.

The manganese content of 0.9 wt % to 1.2 wt % of the corrosion protection layer serves to adjust the strength of the material by the strengthening effect of the manganese by mixed-crystal hardening as well as of the corrosion potential (OCP).

Copper also contributes to the increasing the strength. The content of the alloying element copper in the alloy of the at least one corrosion protection layer is, however, limited to 0.2 wt % in order to avoid too great a shifting of the corrosion potential towards positive values.

Silicon in conjunction with manganese tends to form finely dispersed precipitation particles of the so-called alpha phase (Al₁₂Mn₃Si). On the one hand, these increase the heat resistance of the material and, on the other hand, in the brazing process cause the formation of a coarse-grained recrystallised grain structure strongly stretched in the rolling direction. Both are undesirable because of the manufacturability of the composite material by hot-roll cladding or because of the advantageous fine-grained grain structure in the final product, which is why the silicon content in the alloy of the at least one corrosion protection layer is limited to 0.1 wt %, preferably to 0.05 wt %.

Magnesium as alloying element contributes to increasing the strength. In a brazing process, however, magnesium impairs the brazeability by reacting with the flux to form high-melting phases. The content of magnesium in the alloy of the at least one corrosion protection layer is, therefore, limited to 0.1 wt %.

The alloying element iron is contained in primary aluminium as well as in aluminium scrap. Too low an iron content would, therefore, unnecessarily increase the production costs. Positive is the property of iron to form coarse intermetallic precipitation phases, which during the recrystallisation processes act as nucleators and thus lead to a desirable fine-grained structure. A disadvantage, on the other hand, is an impairment of the corrosion behaviour at higher contents. The iron content in the alloy of the at least one corrosion protection layer is, therefore, limited to at most 0.6 wt %. Preferably, the iron content is at least 0.20 wt % to at most 0.6 wt.-%.

Furthermore, the recyclability of the aluminium composite material and of the products made therefrom is positively influenced by the low copper, silicon and zinc contents as well as by limiting the chromium content of the alloy.

In an embodiment of the aluminium composite material, the corrosion protection layer comprises an aluminium alloy with a maximum Mg content of 0.05 wt %. By a further limitation of the Mg content, the brazeability of the aluminium composite material can be increased further. Also, the formability is improved further, which promotes the bonding to the core material.

In one embodiment of the aluminium composite material, the corrosion protection layer comprises an aluminium alloy with a maximum Cu-content of 0.10 wt %. This can also contribute to an improved formability of the aluminium composite material and also further prevents the formation of local elements.

In another embodiment of the aluminium composite material, the corrosion protection layer comprises an aluminium alloy with a Cr-content of at most 0.10 wt %. Here, the structure of the corrosion protection layer is positively influenced and the formation of local elements prevented further.

In a further embodiment of the aluminium composite material, the aluminium core alloy consists of an aluminium alloy of the type AA 3xxx. Advantageous variants of the AA3xxx alloy are the types AA3005, AA3003 or AA3017. These alloy types and variants based thereon are particularly suitable for use in thermal joining processes and for use in heat exchangers.

In addition, the Cu content of AA 3xxx alloys, in particular of the mentioned alloy types, can be increased to at most 0.7% wt %. Possible minimum Cu contents of the aluminium core alloy are at least 0.3 wt % or at least 0.4 wt %.

The aluminium core alloy may in particular consist of an aluminium alloy with the following composition in wt %:

| | | | | |
|---|---|---|---|---|
| 1.0% | ≤ | Si | ≤ | 0.5%, |
| | | Fe | ≤ | 0.4%, |
| | | Cu | ≤ | 0.7%, |
| | | Mn | ≤ | 1.5%, |
| | | Mg | ≤ | 0.3%, |
| | | Cr | ≤ | 0.3%, |
| | | Zn | ≤ | 0.1%, |
| | | Ti | ≤ | 0.25%, |

the rest Al and unavoidable impurities individually at most 0.05%, in total at most 0.15%.

The indicated aluminium alloys, due to increased Cu contents compared to the usual AA 3xxx alloys, have improved strengths at improved corrosion resistance due to an increased electrochemical potential. They are also preferably used for the manufacture of parts of heat exchangers. In particular, the combination of said aluminium alloys with increased Cu contents has proven to be advantageous with the specific composition of the aluminium alloy provided for the corrosion protection layer, since the corrosion potential between the layers is optimised and the bond in the aluminium composite material is improved.

Preferably, the aluminium composite material is configured such that the corrosion potential of the corrosion protection layer is at least 15 mV, in particular 20 mV lower than the corrosion potential of the core layer. In one embodiment, the corrosion potential of the corrosion protection layer is from 20 mV to 30 mV or 20 mV to 40 mV, more preferably 25 mV to 35 mV lower than the corrosion potential of the core layer. At a corrosion potential difference of less than 15 mV, there is the problem that the effect of the corrosion protection layer to deflect a corrosion attack in the direction of the plane of the corrosion protection layer and thus to reduce the spread in the core layer, is impaired. At too high a potential difference of more than 40 mV, there is the problem that the corrosion protection layer itself is under attack. In addition, there is the risk that at too great a corrosion potential difference, the brazing layer becomes more noble than the corrosion protection layer and as a result the corrosion behaviour of the composite material is clearly worsened. The above-mentioned corrosion potentials usually are measured in accordance with ASTMG69 against a saturated Calomel electrode [Saturated Calomel Electrode, SCE), as shown in the exemplary embodiments.

In a further embodiment of the aluminium composite material, the aluminium core alloy has an Si content of not more than 0.20 wt %. This has a positive effect on the structure of the core layer.

In another embodiment of the aluminium composite material, the aluminium core alloy has a Cr content of not more than 0.15 wt %. As a result, especially the recyclability of the aluminium composite material is increased.

In a further embodiment of the aluminium composite material, the corrosion protection layer has a thickness of at least 20 μm. This ensures an adequate corrosion protection. If the thickness of the corrosion protection layer is 30 μm μm to 80 μm, an improved corrosion protection is achieved while at the same time saving material.

As relative thickness, in particular for the corrosion protection layer, a thickness of 10% to 20% of the total thickness of the aluminium composite material is suitable. In the case of several corrosion protection layers, for example a two-sided version, a thickness of 10% to 20% of the total thickness of the aluminium composite material can be used.

The aluminium composite material according to another embodiment preferably has an average thickness of 0.1 to 5 mm and more preferably from 0.2 to 3 mm or 0.5 mm to 1.5 mm. With these thickness ranges, a wide spectrum of applications, especially also in the field of heat exchangers, can be covered.

In a further embodiment of the aluminium composite material, at least one further outer layer is provided. The at least one further outer layer may comprise a brazing layer of an aluminium brazing alloy. The aluminium brazing alloy can meet the specifications of type AA 4xxx, especially AA 4004, AA 4343 and AA 4045, which show excellent brazing properties when used in heat exchangers.

With a brazing layer, the preparation of the braze for a thermal joining can be easily combined with the above-described corrosion protection. Advantageous for the corrosion protection is an arrangement of the corrosion protection layer between the core layer and the brazing layer, wherein the corrosion protection layer rests in particular directly on the core layer and/or the brazing layer. In a particularly simple embodiment of the aluminium composite material three layers are provided, wherein the corrosion protection layer is arranged between the core layer and the brazing layer. In a four-layer variant, a further corrosion protection layer or a further brazing layer is additionally provided on the side of the core layer which faces away from the corrosion protection layer and the brazing layer. Furthermore, a five-layer variant can be provided, wherein in each case a corrosion protection layer is located on both sides of the core layer and between the core layer and in each case an outer brazing layer.

Additionally or alternatively, at least one further protective layer may be provided. This may comprise, in addition to the alloy indicated in claim 1, also the alloys of the type AA 7xxx, in particular AA 7072 and of the type AA 1xxx, in particular AA 1050. With a further protective layer the corrosion resistance can be improved further. The further protective layer is arranged in particular on the side of the core layer, which faces away from the side on which the corrosion protection layer is arranged.

As relative thickness for the further outer layer, in particular a brazing layer, a thickness of 5% to 10% of the total thickness of the aluminium composite material can be used.

According to a further teaching, the aforementioned object concerning a method for producing an aluminium composite material, in particular an aluminium composite material as described above, with which at least one core layer comprising an aluminium core alloy is provided and at least one corrosion protection layer is applied on one side or both sides of the core layer, is solved in that for the corrosion protection layer an aluminium alloy with the following composition in wt % is used:

| | | | | |
|---|---|---|---|---|
| 0.9% | ≤ | Si | ≤ | 0.10%, |
| | | Fe | ≤ | 0.6%, |
| | | Cu | ≤ | 0.2%, |
| | | Mn | ≤ | 1.2%, |
| | | Mg | ≤ | 0.10%, |
| | | Cr | ≤ | 0.3%, |
| | | Zn | ≤ | 0.1%, |
| | | Ti | ≤ | 0.1%, |

the rest Al and unavoidable impurities, individually at most 0.05%, in total at most 0.15%.

As already indicated in connection with the aluminium composite material, this shows, with the specifically selected composition of the aluminium alloy of the corrosion protection layer, in addition to an extremely low material loss under corrosive conditions, a significantly improved manufacturability by an optimised bonding property with the core layer. This can be attributed especially to the mechanical properties of the alloy of the corrosion protection layer, which allows the corrosion protection layer to be applied particularly reliably onto the core layer.

If the aluminium composite material is produced by roll-cladding a plating package, it is possible with the composition of the aluminium alloy of the corrosion protection layer to achieve high strip qualities with good bonding properties even with low rolling forces. In addition this provides a composite material that can be produced on an economically large scale. With a plating package several materials, here an ingot for the core layer and at least one plating sheet for the corrosion protection layer, are placed on top of one another. Subsequently, the materials are joined together in a rolling process under pressure.

Further possibilities for producing the aluminium composite material are provided by a simultaneous casting or the application of the corrosion protection layer and possibly further layers by thermal spraying. However, roll-cladding and simultaneous casting are currently the most widely used methods for producing an aluminium composite material, with the cast material being distinguished from the discrete layer compositions of the roll-cladded material by its clear concentration gradients between the various aluminium alloy layers. During roll-cladding, only slight diffusion processes take place between the layers.

The method may include further rolling passes, in particular with a roll-cladding process. In one embodiment, the aluminium composite material is hot rolled and optionally cold rolled to a final thickness. With this, optionally an interim annealing of the aluminium composite material may take place.

In one embodiment of the method, the plating package is preheated to a temperature of at least 450° C. before the roll-cladding. The plating package is fed to the roll cladding stand at a corresponding temperature. With this a hot rolling is carried out for the plating, resulting in a particularly effective bond between the layers. Preheating to a temperature of 460° C. to 500° C. optimises the process reliability of the roll-cladding.

Subsequently, the hot rolled composite material can be brought to the required final thickness by further cold rolling. An optional intermediate annealing can be carried out to soften the material and facilitate the further cold forming.

The aluminium composite material can finally be brought into a specific state by annealing, in particular so as to suitably adjust the mechanical properties of the aluminium composite material in accordance with the intended use, for example in a heat exchanger.

If with the process the aluminium composite material is subjected to a final annealing at a material temperature of at most 350° C. to 400° C., a soft annealed state of the aluminium composite material can be achieved. For this, in particular, the maximum holding time at said maximum temperatures amounts to 2 h to 4 h. The state reached is called temper 0.

If the aluminium composite material is subjected to a final annealing at a material temperature of a maximum of 250° C. to 320° C., a partially annealed state of the aluminium composite material is achieved. In particular, the maximum holding time for this at the corresponding maximum temperatures is 2 h to 4 h. The state reached is called temper H24.

According to a further teaching, the above object is achieved by using an aluminium composite material described above for producing a heat exchanger or components of a heat exchanger.

As already described in the introduction, heat exchangers and their components have special requirements with regard to corrosion protection. These requirements can be met particularly comprehensively with the described aluminium composite material.

In one embodiment of the use, the described aluminium composite material is used to produce a charge air cooler or a component of a charge air cooler, a water cooler or air-cooled condenser. Charge air coolers, because of the possible condensate formation of corrosion-promoting substances, are subjected to a particularly aggressive corrosion attack, which can be countered with the excellent properties of the described aluminium composite material. Particularly advantageous is the use for producing a charge air cooler for use in motor vehicles with low pressure exhaust gas recirculation, with which variable amounts of exhaust gases are mixed into the sucked-up combustion air. In particular, the use comprises a thermal joining, for example a brazing in a CAB-process, by which an advantageous microstructure of the aluminium composite material is adjusted.

In a further embodiment of the use, the heat exchanger has cavities, in particular inside pipes, wherein the corrosion protection layer is arranged on the inside of the cavities. As already described, in particular with charge air coolers a corrosive condensate forms inside the cavities of the heat exchanger, so that with a suitable arrangement of the corrosion protection layer the particularly effective corrosion protection is optimally applied.

Finally, the abovementioned object is achieved by a component comprising an aluminium composite material as described above. If the component has a thermally joined construction, a formation of an advantageous recrystallised grain structure in the component after the thermal joining is ensured. By the configuration of the corrosion protection layer according to the invention in terms of composition, a favourable fine-grained grain structure can be achieved, which limits the lateral spread of the corrosion and thus avoids the formation of larger detachments during operation.

The component can be configured as a heat exchanger, in particular as a charge air cooler or as a component of a charge air cooler, as a water cooler or air-cooled condenser. If the heat exchanger has cavities, in particular inside pipes, the corrosion protection layer is preferably arranged on the inside of the cavities.

### BRIEF DESCRIPTION OF THE DRAWINGS

With regard to further embodiments and advantages of the method, the use and the component, reference is made to the statements in respect of the aluminium composite material as well as to the following description of exemplary embodiments in conjunction with the drawing. In the drawing:

FIG. 1 shows an exemplary embodiment of an aluminium composite material;

FIGS. 2a and 2b show metallographic sections through strip samples of an exemplary embodiment of an aluminium composite material and a comparative sample after six weeks of a condensate corrosion test;

FIG. 3 shows an exemplary embodiment of a method for producing an aluminium composite material; and

FIG. 4 shows an exemplary embodiment of a heat exchanger component.

### DETAILED DESCRIPTION

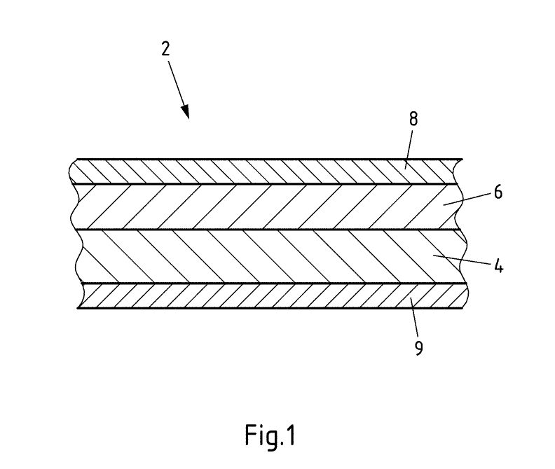

FIG. 1 shows an exemplary embodiment of an aluminium composite material 2 for use in the manufacture of heat exchangers. A core layer 4 comprising an aluminium core alloy of the type AA 3xxx with an additional maximum Cu content of 0.7 wt % is provided. On the core layer 4 a corrosion layer 6 is applied, which has an aluminium alloy with the following composition in wt %:

| | | | | |
|---|---|---|---|---|
| 0.9% | ≤ | Si | ≤ | 0.10%, |
| | | Fe | ≤ | 0.6%, |
| | | Cu | ≤ | 0.2%, |
| | | Mn | ≤ | 1.2%, |
| | | Mg | ≤ | 0.10%, |
| | | Cr | ≤ | 0.3%, |
| | | Zn | ≤ | 0.1%, |
| | | Ti | ≤ | 0.1%, |

the rest Al and unavoidable impurities, individually at most 0.05%, in total at most 0.15%. The corrosion protection layer 6 has a thickness of 30 μm to 80 μm.

The illustrated corrosion protection layer preferably has a Mg content of at most 0.05 wt %, a Cu content of at most 0.1 wt % and a Cr content of at most 0.10 wt % in order to provide improved properties. In addition, a limitation of the Si content to a maximum of 0.05 wt % is possible in order to reduce the formation of alpha phases (Al₁₂Mn₃Si).

A further outer layer is provided, which is in the form of a brazing layer 8 and consists of an aluminium brazing alloy of the type AA 4xxx. In addition, a further brazing layer 9 made of an aluminium brazing alloy of the type AA 4xxx is provided on the side of the core layer 2, which faces away from the corrosion protection layer 6.

The aluminium composite material 2 is in the form of a strip which has been produced by roll-cladding. Due to the specific composition of the aluminium alloy of the corrosion protection layer, especially in conjunction with the composition of the core layer, the bonding properties of the layers are improved, which is optimally exploited by a roll-cladding. As a result, the aluminium composite material 2 has excellent corrosion resistance.

To analyse the corrosion resistance of the aluminium composite material also under a condensate formation of corrosive media, such as those that occur in charge air coolers, various samples of aluminium composite materials were subjected to a condensate corrosion test developed for this purpose.

Three different compositions of aluminium composite materials were tested. Sample A consisted of three layers with an intermediate alloy according to the invention for the corrosion protection layer. Sample B also consisted of three layers, but with an intermediate conventional alloy for the corrosion protection layer. Sample C was in the form of a two-layered composite material with a brazing layer without a corrosion protection layer. The exact alloy components are listed in Tab. 1a-c.

TABLE 1a

| Sample A | | | | | | | | |
|---|---|---|---|---|---|---|---|---|
| (inventive) | Si | Fe | Cu | Mn | Mg | Cr | Zn | Ti |
| Core layer | 0.04 | 0.17 | 0.44 | 1.14 | 0.22 | 0.08 | <0.01 | 0.01 |
| Corrosion | 0.04 | 0.48 | 0.06 | 1.06 | 0.01 | <0.01 | <0.01 | 0.01 |
| protection | | | | | | | | |
| layer | | | | | | | | |
| Brazing layer | 10.0 | 0.09 | 0.00 | 0.00 | 0.00 | <0.01 | <0.01 | 0.01 |

TABLE 1b

| Sample B | | | | | | | | |
|---|---|---|---|---|---|---|---|---|
| (Comparison) | Si | Fe | Cu | Mn | Mg | Cr | Zn | Ti |
| Core layer | 0.11 | 0.36 | 0.45 | 1.2 | 0.00 | <0.01 | <0.01 | 0.13 |
| Corrosion | 0.61 | 0.31 | 0.00 | 1.4 | 0.08 | 0.12 | <0.01 | 0.01 |
| protection | | | | | | | | |
| layer | | | | | | | | |
| Brazing layer | 10.0 | 0.09 | 0.00 | 0.00 | 0.00 | <0.01 | <0.01 | 0.01 |

TABLE 1c

| Sample C | | | | | | | | |
|---|---|---|---|---|---|---|---|---|
| (Comparison) | Si | Fe | Cu | Mn | Mg | Cr | Zn | Ti |
| Core layer | 0.06 | 0.19 | 0.19 | 1.14 | 0.21 | <0.01 | <0.01 | 0.15 |
| Brazing layer | 10.0 | 0.09 | 0.00 | 0.00 | 0.00 | <0.01 | <0.01 | 0.01 |

First, three rolling ingots each with a cross section of 125 mm×350 mm with mass of 60 kg were cast for the core layer, corrosion protection layers and brazing layers. The rolling ingots for the brazing layers and the corrosion protection layers were subsequently hot-rolled to the required plating layer thicknesses. Plating packages were produced from in each instance one ingot for the core layer and the rolled plating sheets. After preheating to 470° C. at a holding time of at least 3 h the plating packages were rolled in several rolling passes to a thickness of 7 mm. By several subsequent cold-rolling passes a final thickness of 0.40 mm was obtained. By a final annealing at a temperature of 300° C. with a holding time of 2 h, the partially annealed Temper H24 was set. With the samples the thickness of the brazing layer amounted to 7.5% of the overall thickness of the aluminium composite material. The thickness of the corrosion protection layer was 15% of the total thickness of the aluminium composite material.

To test the corrosion resistance against aggressive exhaust gas condensates, tests were carried out in accordance with the VDA Test Sheet 230-214. Test strips measuring 30 mm×120 mm were first subjected to annealing with a holding time of 3 minutes at 600° C. This annealing served to adjust a material state, as occurs in the application case after a brazing. Subsequently, the side of the samples on which no corrosion protection layer was arranged was covered with adhesive tape. With the samples prepared in this way a cyclic test was carried out over a total time of maximum six weeks.

The test consisted of three consecutive phases:
Immersing the sample in the test solution up to half the sample length over a period of 6 h
drying the sample in ambient air for a period of 2 hours
placing the sample in the vapour phase above the test solution for a period of 16 h

The test solution was prepared on the basis of water by adding the following substances:
Sulphate (added as sulphuric acid): 100 mg/l
Nitrate (added as sodium nitrate): 1000 mg/l
Formate (added as formic acid): 650 mg/l
Acetate (added as acetic acid): 500 mg/l
Chloride (added as NaCl): 1000 mg/l

The pH of the test solution was about 2.6. The test temperature was 50° C.

The results of the mass loss of the samples as a function of the duration are given in Tab. 2.

TABLE 2

| Mass loss (g) | 2 weeks | 4 weeks | 6 weeks |
|---|---|---|---|
| Sample A | 0.02 | 0.03 | 0.05 |
| (invention) | | | |
| Sample B | 0.04 | 0.06 | 0.08 |
| (comparison) | | | |
| Sample C | 0.04 | 0.07 | 0.19 |
| (comparison) | | | |

The sample A according to the invention clearly showed the best corrosion resistance with the lowest mass loss. The mass loss compared to an aluminium composite material without corrosion protection layer (sample C) and an aluminium composite material with conventional corrosion protection layer (sample B) could be significantly reduced, also under aggressive corrosive conditions.

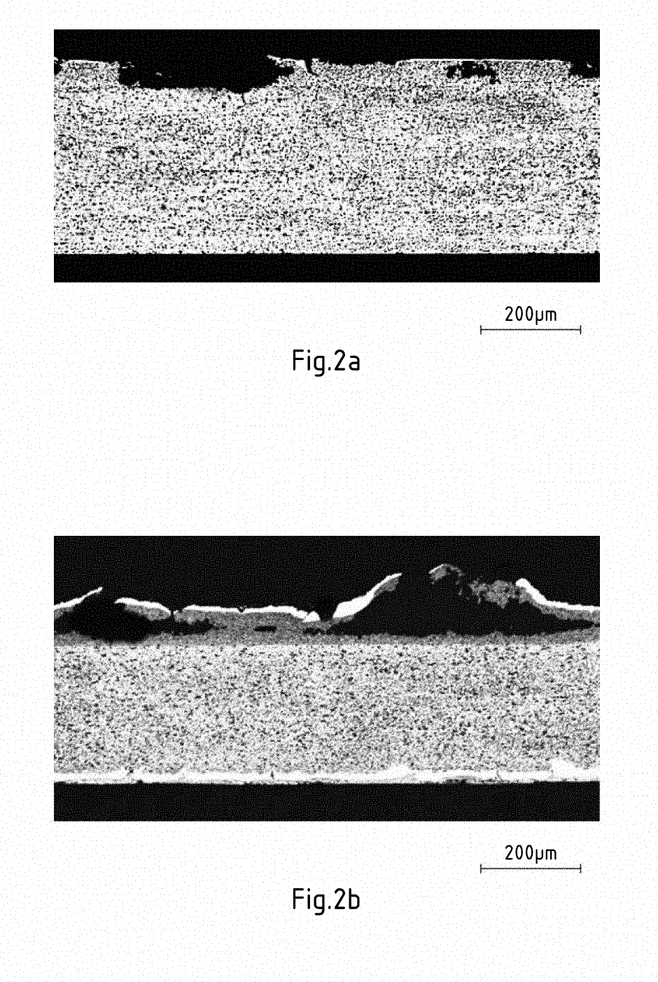

In addition, on strip samples after six weeks test time, metallographic investigations were carried out in the corrosively most strongly attacked areas. As shown in FIG. 2a, the corrosion in sample A according to the invention is limited to a local corrosion of the corrosion protection layer, which is also not interrupted. An extended lateral spread of the corrosion attack as with the comparative sample B in FIG. 2b does not occur. It can, therefore, be assumed that the size of detached corrosion particles on sample A is significantly reduced compared to sample B.

In addition, the corrosion potentials of the materials mentioned in Tab. 1 a-c were investigated. The corrosion potentials are usually measured on monolithic material samples having identical alloy compositions so as to achieve a higher measurement accuracy. The corrosion potential was measured in each case according to the standard ASTM G69 against a saturated calomel electrode (Saturated Calomel Electrode, SCE). The corrosion potentials are listed in Table 3.

TABLE 3

| Corrosion potential | Core layer | Corrosion protection layer |
|---|---|---|
| Sample A (inventive) | −687 mV | −717 mV |
| Sample B (comparison) | −698 mV | −745 mV |
| Sample C (comparison) | −699 mV | — |

The corrosion potential of the corrosion protection layer in the inventive sample A lies here in a preferred range of 20 mV to 30 mV respectively 20 mV to 40 mV, in particular 25 mV to 35 mV lower than in the core layer. The comparative sample B shows a clear difference in the corrosion potentials. The aluminium alloys of sample A show in the composite material an improved corrosion behaviour compared to the comparison composite material, which has aluminium alloys with the composition of sample B.

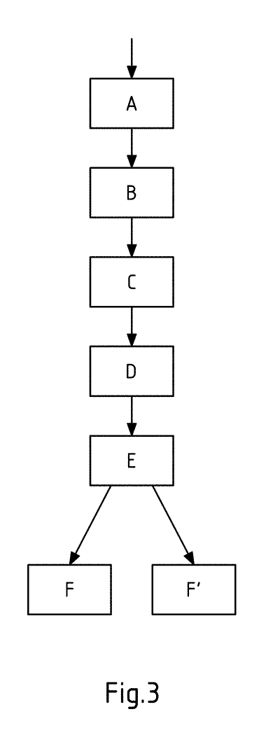

FIG. 3 shows an exemplary embodiment of a method for producing an aluminium composite material. In step A a plating package is provided, wherein at least one plating sheet is arranged on an ingot for the core layer with corresponding compositions arranged on top of one another. In step B the plating package is preheated to a temperature of at least 450° C., in particular to a temperature of 460° C. to 500° C. In step C, the preheated plating package is rolled on a rolling stand into an aluminium composite material in the form of a strip.

The roll cladding in step C is followed, in the optional step D, by at least one additional hot rolling step. The first rolling passes, in particular the rolling pass in step C, can be carried out in such a way, for example with regard to the reduction per pass, that an optimum bonding of the plating sheets to the core layer is achieved. Next the reduction per pass is increased and the composite material is rolled like a homogeneous material to a final hot strip thickness. With the at least one additional hot pass in step D, a hot rolling can then take place with, for example, higher reductions per pass than in step C in order to increase the productivity. Steps C and D can take place on the same roll stand, for example a reversing stand or on different roll stands.

With step C and optionally with the additional step D, an intermediate thickness of 2 mm to 10 mm is achieved. In step E, cold rolling of the aluminium composite material to an average thickness of 0.1 to 5 mm is carried out. Optionally, an intermediate annealing can be carried out in order to soften the material and to facilitate the further cold forming.

In step F or F′, a final annealing of the cold-rolled aluminium composite material takes place. In alternative F, the aluminium composite material is subjected to a final annealing at a material temperature of at most 350° C. to 400° C. with a maximum hold time of 2 h to 4 h, to achieve a soft annealed state with Temper 0. According to alternative F′, the aluminium composite material is subjected to a final annealing at a material temperature of at most 250° C. to 320° C. with a maximum holding time of 2 h to 4 h to achieve a partially annealed state with Temper H24.

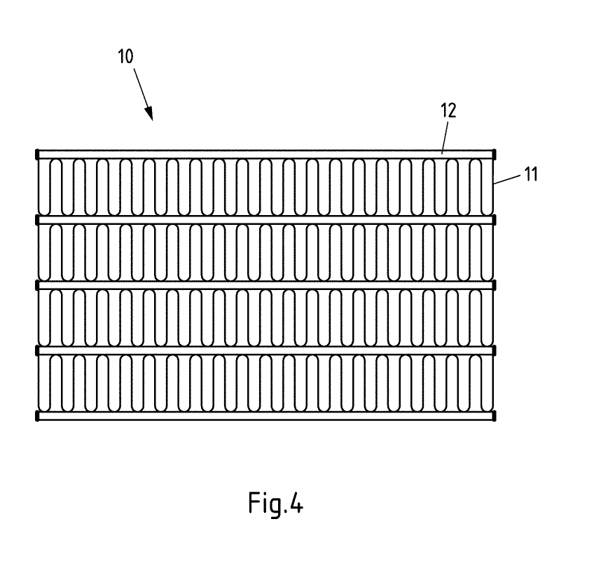

FIG. 4 shows an exemplary embodiment of a heat exchanger 10 is shown in a plan view. The components of the heat exchanger, e.g. the fins 11 of the heat exchanger 10, consist of an aluminium composite material, either bare or coated on both sides with an aluminium braze. The fins 11 are bent in a meander-shaped manner and brazed to tubes 12, so that a plurality of brazing joints is required. Instead of the tubes 12, it is also possible to use shaped plates which form cavities for guiding media. The tubes 12 may also be made of the aluminium composite material, since they carry the medium and therefore must be protected against corrosion. When using the heat exchanger, a condensate of corrosive substances can form on the surface of the heat exchanger 10, so that a use of the aluminium composite material according to the invention is particularly advantageous

In an embodiment of the heat exchanger 10 as charge air cooler, there are in particular two embodiments. With the conventional design the charge air flows through the tubes 12. The tubes 12 are brazed to outer fins 11, which are cooled by the airstream. With the indirectly cooled design, the charge air flows through the tubes 12 and cooling liquid flows around them, which ensures an indirect cooling via the cooling liquid.

In both embodiments, the corrosive condensates form inside the tubes 12 or inside the cavities. The corrosion protection layer is therefore advantageously arranged on the charge air side, i.e. inside the tubes 12 or the charge air cooler.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An aluminium composite material, comprising:
at least one core layer having an aluminium core alloy; and
at least one corrosion protection layer arranged on the core layer;
wherein the at least one corrosion protection layer has an aluminium alloy with the following composition in wt %:

| | | | | |
|---|---|---|---|---|
| 0.9% | ≤ | Si | ≤ | 0.10%, |
| | | Fe | ≤ | 0.6%, |
| | | Cu | ≤ | 0.2%, |
| | | Mn | ≤ | 1.2%, |
| | | Mg | ≤ | 0.10%, |
| | | Cr | ≤ | 0.3%, |
| | | Zn | ≤ | 0.1%, |
| | | Ti | ≤ | 0.1%, |

the rest Al and unavoidable impurities, individually at most 0.05%, in total at most 0.15%.

2. The aluminium composite material according to claim 1, wherein the at least one corrosion protection layer has an aluminium alloy with an Mg-content of at most 0.05 wt %.

3. The aluminium composite material according to claim 1, wherein the at least one corrosion protection layer comprises an aluminium alloy with a Cu content of at most 0.10 wt %.

4. The aluminium composite material according to claim 1, wherein the at least one corrosion protection layer comprises an aluminium alloy with a Cr content of at most 0.10 wt %.

5. The aluminium composite material according to claim 1, wherein the aluminium core alloy consists of an aluminium alloy of the type AA 3xxx, optionally with a Cu content of at most 0.7 wt %.

6. The aluminium composite material according to claim 1, wherein the aluminium core alloy consists of an aluminium alloy with the following composition in wt %:

| | | | | |
|---|---|---|---|---|
| 1.0% | ≤ | Si | ≤ | 0.5%, |
| | | Fe | ≤ | 0.4%, |
| | | Cu | ≤ | 0.7%, |
| | | Mn | ≤ | 1.5%, |
| | | Mg | ≤ | 0.3%, |
| | | Cr | ≤ | 0.3%, |
| | | Zn | ≤ | 0.1%, |
| | | Ti | ≤ | 0.25%, |

the rest Al and unavoidable impurities individually at most 0.05%, in total at most 0.15%.

7. The aluminium composite material according to claim 1, wherein the corrosion potential of the corrosion protection layer is at least 15 mV, in particular 20 mV, preferably between 20 mV and 40 mV or 20 mV to 30 mV, or more preferably between 25 mV and 35 mV lower than the corrosion potential of the core layer.

8. The aluminium composite material according to claim 1, wherein at least one further outer layer is provided, in particular at least one brazing layer of an aluminium brazing alloy and/or at least one further protection layer.

9. A method for producing an aluminium composite material, in particular an aluminum composite material according to claim 1, comprising the steps of:
providing at least one core layer comprising an aluminium core alloy; and
applying at least one corrosion protection layer on one side or both sides of the core layer;
wherein for the at least one corrosion protection layer an aluminium alloy with the following composition in wt % is used:

| | | | | |
|---|---|---|---|---|
| 0.9% | ≤ | Si | ≤ | 0.10%, |
| | | Fe | ≤ | 0.6%, |
| | | Cu | ≤ | 0.2%, |
| | | Mn | ≤ | 1.2%, |
| | | Mg | ≤ | 0.10%, |
| | | Cr | ≤ | 0.3%, |
| | | Zn | ≤ | 0.1%, |
| | | Ti | ≤ | 0.1%, |

the rest Al and unavoidable impurities, individually at most 0.05%, in total at most 0.15%.

10. The method according to claim 9, further comprising the step of producing the aluminium composite material by roll-cladding a plating package.

11. The method according to claim 10, further comprising the step of preheating the plating package, prior to the roll-cladding, to a temperature of at least 450° C., in particular to a temperature of 460° C. to 500° C.

12. The method according to claim 9, further comprising the step of subjecting the aluminium composite material to a final annealing.

13. Use of an aluminium composite material according to claim 1 for the manufacture of a heat exchanger or components of a heat exchanger.

14. A heat exchanger or component of a heat exchanger comprising an aluminium composite material according to claim 1.

15. The heat exchanger or component of a heat exchanger according to claim 14, wherein at least one thermally joined connection of parts of the heat exchanger or component is provided.

16. The heat exchanger or component of a heat exchanger according to claim 14, wherein the heat exchanger is configured as a charge air cooler.
